(19) United States
(12) Patent Application Publication
(10) Pub. No.: US 2008/0012689 A1
(43) Pub. Date: Jan. 17, 2008

(54) RADIO FREQUENCY IDENTIFICATION SYSTEM AND METHOD THEREOF

(75) Inventors: Hsin-Chin Liu, Taipei City (TW); Yung-Ting Chen, Changhua County (TW)

Correspondence Address: PATTERSON, THUENTE, SKAAR & CHRISTENSEN, P.A., 4800 IDS CENTER, 80 SOUTH 8TH STREET, MINNEAPOLIS, MN, 55402-2100, US

(73) Assignee: YFY RFID TECHNOLOGIES COMPANY LIMITED, Tortola (VG)

(21) Appl. No.: 11/776,167

(22) Filed: Jul. 11, 2007

Related U.S. Application Data
(60) Provisional application No. 60/830,577, filed on Jul. 12, 2006.

(51) Int. Cl. H04Q 5/22; G08B 13/14; H04B 7/00

(52) U.S. Cl. 340/10.1; 340/572.1

(57) ABSTRACT

A radio frequency identification (RFID) system for communicating with an RFID tag and method thereof are provided. The RFID system comprises a first power supplier, a transmitter, and a receiver. The first power supplier is configured to provide power to the RFID tag. The transmitter is configured to send a command to the RFID tag. The receiver is configured to receive a first response signal from the REID tag, wherein the first response signal is generated in response to the command.

This application claims the benefit of U.S. Provisional Patent Application No. 60/830,577 filed on Jul. 12, 2006.

### CROSS-REFERENCES TO RELATED APPLICATIONS

Not applicable.

### BACKGROUND OF THE INVENTION

1. Field of the Invention

The present invention relates to a radio frequency identification system (RFID system) and method thereof. More particularly, the present invention relates to a radio frequency identification system having an independent power supplier and method thereof.

2. Descriptions of the Related Art

Radio Frequency Identification systems have already entered the commercialized era. A conventional RFID system comprises at least an RFID tag, an RFID reader and a backend management system. The conventional RFID system can be classified into different categories according to its frequency (e.g., low frequency, high frequency, super high frequency and microwave) or types of the RFID tags. The types of the RFID tags include active and passive tags. An active tag has its own power inside that can be supplied to an RFID chip of the active tag. Since it has power, it provides longer communication distance and better communication quality for the RFID system. In contrast, a passive tag, without its own power, obtains power from a continuous wave of a signal transmitted by the RFID reader, wherein the obtained power is used to drive an RFID chip inside the passive tag. The advantages of passive tags are longer lifetime and no need for battery replacement. However, its communication distance is shorter and communication quality is less desirable comparing to the active tag.

For an RFID system using passive tags, the main issue is how a reader can efficiently read data from the tags in a certain distance. Proposed solutions of the prior art are as followings: making improvements on antenna design of the RFID tag, increasing the coverage of the radio wave, and changing the transmission way of the radio wave.

Referring to FIG. 1, it is a schematic diagram of a conventional REID system 1. The RFID system 1 comprises a reader 10 and a passive REID tag 11. In the RFID system 1, the reader 10 is configured to supply power to the passive RFID tag 11 to power it up by its continuous wave, to send a command to the passive REID tag 11, and to receive a response signal from the passive RFID tag 11. More particularly, the passive RFID tag 11 generates random 16-bit information and sends to the reader 10, the reader 10 then replies an acknowledge information to the passive RFID tag 11 when it successfully receives the random 16-bit information, and then the passive RFID tag 11 sends an electronic product code (EPC) to the reader 10. The passive RFID tag 11 is shown in FIG. 2, which comprises a rectifier 110, an envelope detector 111, a low pass filter 112, and a hysteresis comparator 113. The passive RFID tag 11 is designed according to the RFID tag standards that are well-known in this technical field so the details of the RFID tag standards are not described herein.

Particularly, the reader 10 comprises a transmitter 100, and a receiver 101. The transmitter 100 is configured to send out the command as well as power to the passive REID tag 11. The passive RFID tag 11 is powered up by the power and transmits the response signal in response to the command. The receiver 101 is then configured to receive the response signal. The RF envelope of the command is shown in FIG. 3. The command starts at a falling edge 30 and ends at a rising edge 31 to allow the passive RFID tag 11 to identify the period of the command.

Now referring to FIG. 4, generally the fading of a radio wave depends on the transmission distance between the REID tag 11 and the reader 10. More particularly, the fading of the radio wave is proportional to the square of the transmission distance d₀. After the reader 10 transmits a radio signal 401 carried by a continuous wave to the passive tag 11, the passive tag 11 returns a response signal 403 to the reader 10. In this manner, the radio signal 401 is faded by the square of the transmission distance d₀ when received by the passive tag 11. The response signal 403 is faded by the square of the transmission distance d₀ again when received by the reader 10. Thus, the reader 10 receives the response signal 403 whose power is faded by a fourth power of the distance d₀ comparing to the original radio signal 401. According to the aforementioned principle, the signal fading between the reader 10 and the passive RFID tag 11 is proportional to the fourth power of distance.

Because the strength of the radio signal depends highly on the transmission distance between a reader and an RFID tag, how to find a solution that reduces the influence of the transmission distance in the RFID system is still an objective to those skilled in the art.

### SUMMARY OF THE INVENTION

One objective of this invention is to provide an RFID system for communicating with an RFID tag. The RFID system comprises a power supplier, a transmitter, and a receiver. The power supplier is configured to provide power to the RFID tag. The transmitter is configured to send a command to the RFID tag. The receiver is configured to receive a response signal from the RFID tag, wherein the response signal is generated in response to the command.

Another objective of this invention is to provide a method for communicating with an RFID tag. The method comprises the steps of: providing a power supplier to provide power to the RFID tag; providing a transmitter to send a command to the RFID tag; and receiving a response signal from the RFID tag, wherein the response signal is generated in response to the command.

The present invention introduces an independent power supplier to supply power to passive RFID tags. The power supplier is deployed at the proximity of the RFID tags to decrease required power supplied the RFID tag. The present invention can effectively overcome the influence of the transmission distance.

The detailed technology and preferred embodiments implemented for the subject invention are described in the following paragraphs accompanying the appended drawings for people skilled in this field to well appreciate the features of the claimed invention.

### BRIEF DESCRIPTION OF THE DRAWINGS

FIG. 1 is a schematic diagram of the conventional REID system having a passive tag;

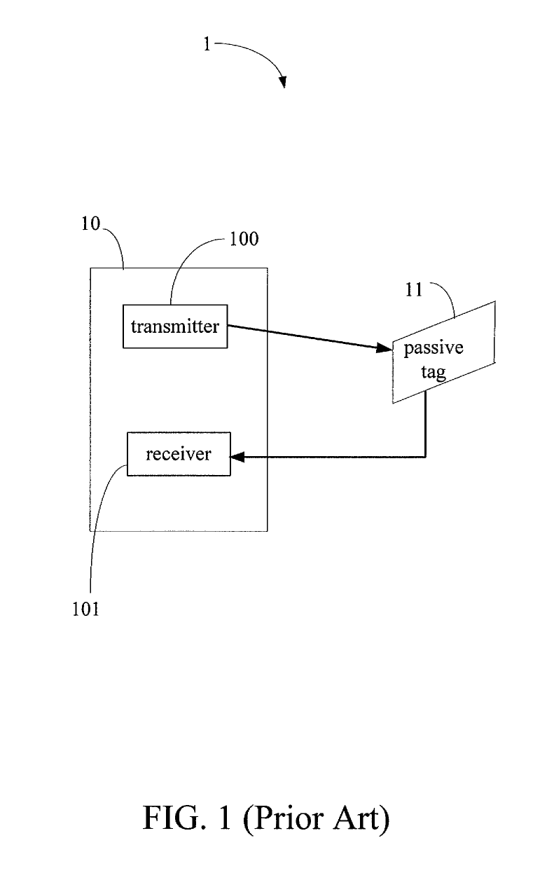

FIG. 2 is a schematic diagram of the passive tag;

FIG. 3 is a waveform of RF envelope of the command;

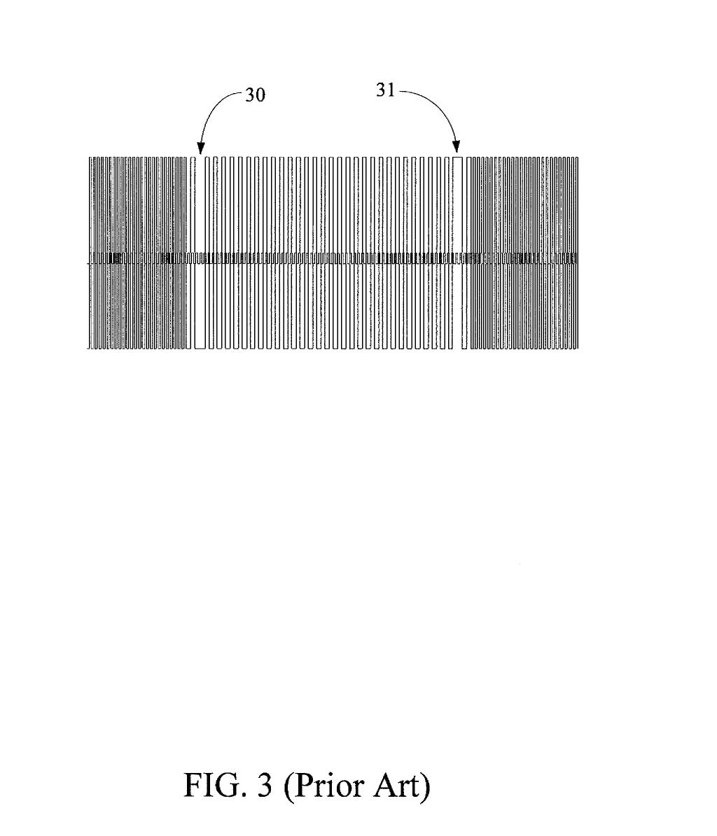

FIG. 4 is a schematic diagram of distance between the reader and the passive tag in the conventional RFID system;

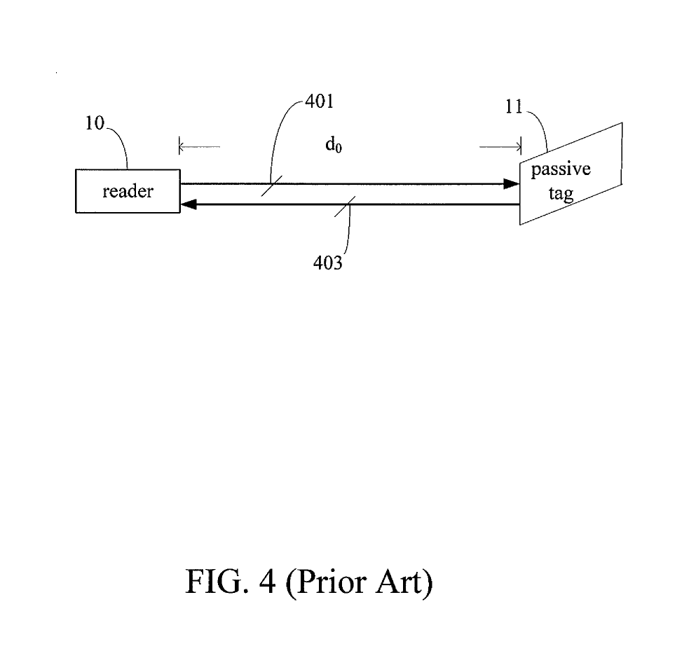

FIG. 5 is a schematic diagram of the RFID system of the present invention;

FIG. 6 is a waveform of RF envelope of the command of the present invention;

FIG. 7 is a schematic diagram of another RFID system of the present invention;

FIG. 8 is a schematic diagram of distance between the reader and the passive tag in the REID system of the present invention;

FIG. 9 is a flow chart of the method of the present invention;

FIG. 10A is a flow chart of another method of the present invention; and

FIG. 10B is a flow chart of another method of the present invention.

### DESCRIPTION OF THE PREFERRED EMBODIMENT

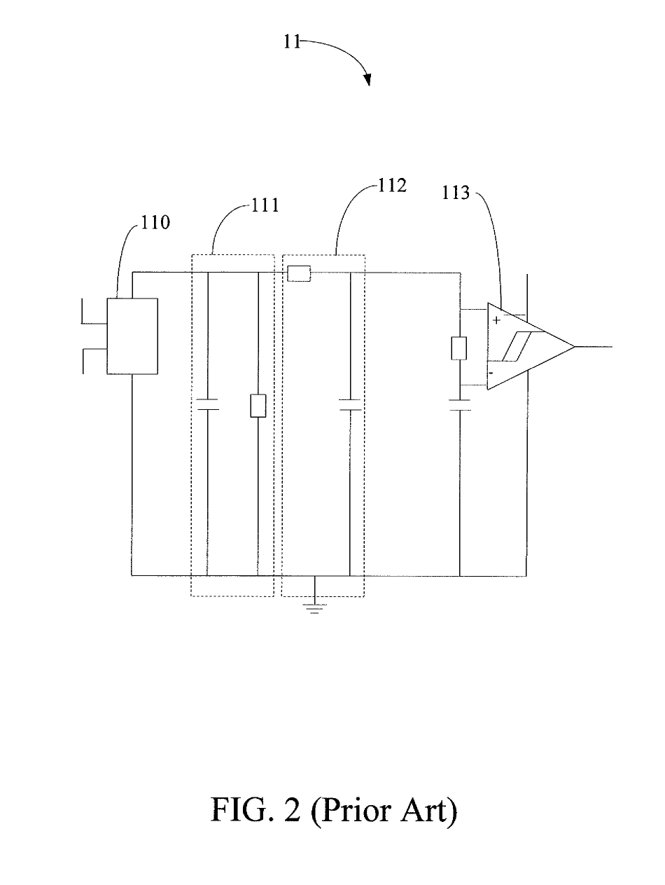

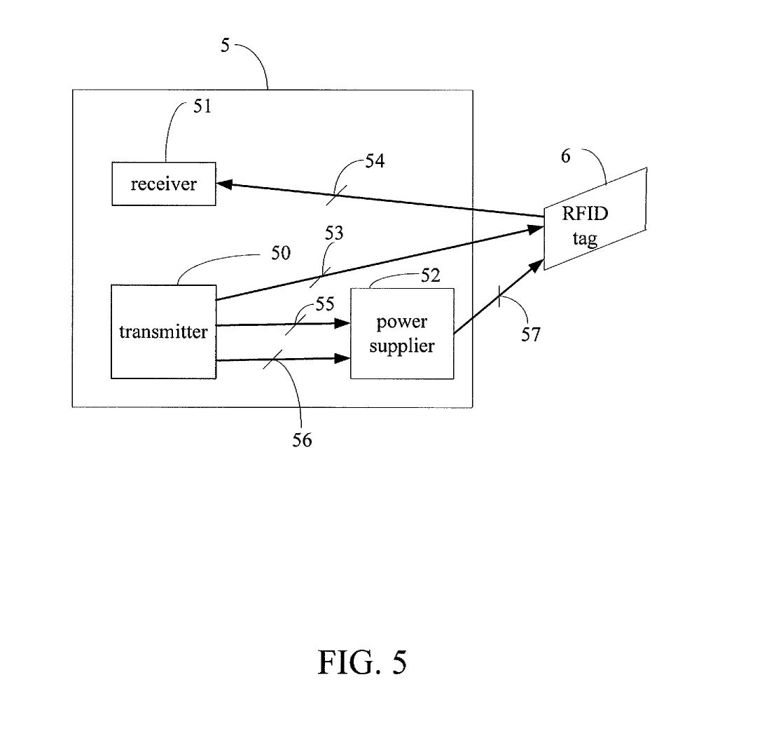

Please refer to FIG. 5, which is a first embodiment of an RFID system 5 of the present invention for communicating with an RFID tag 6, wherein the RFID tag 6 is a passive RFID tag having the circuit shown in FIG. 2. The RFID system 5 comprises a transmitter 50, a receiver 51, and a power supplier 52. In general, the transmitter 50 and receiver 51 are integrated into a reader.

The power supplier 52, a continuation wave emitter, is isolated from the transmitter 50 and receiver 51 to provide power to the RFID tag 6. The RFID tag 6 can be powered up by the power provided by the power supplier 52 and then operates in a standby state. After the RFID tag 6 is powered up, the transmitter 50 is configured to send a command 53 to the RFID tag 6. After receiving the command 53, the RFID tag 6 generates a first response signal 54 in response to the command 53. The receiver 51 is configured to receive the first response signal 54. More particularly, the passive RFID tag 11 generates random 16-bit information and sends to the receiver 51, the receiver 51 then replies acknowledge information to the passive RFID tag 11 when it successfully receives the random 16-bit information After that, the passive RFID tag 11 sends an electronic product code (EPC) to the receiver 51.

Particularly, the transmitter 50 first sends an enable signal 55 to turn on the power supplier 52 before sending the command 53 to the RFID tag 6. The power supplier 52, responsive to the enable signal 55, starts to provide power to the RFID tag 6, wherein the power is provided via a continuous electromagnetic wave 57. After receiving the first response signal 54, the receiver 51 may send a disable signal 56 to turn off the power supplier 52. It is noted that the receiver 51 is unnecessary to turn off the power supplier 52 right after receiving the first response signal 54. It may send the disable signal 56 after certain operations of the RFID system 5. To conform to the Gen2 standard, the command 53 starts with a head detection symbol to provide a rising edge and ends with a tail detection symbol to provide a falling edge.

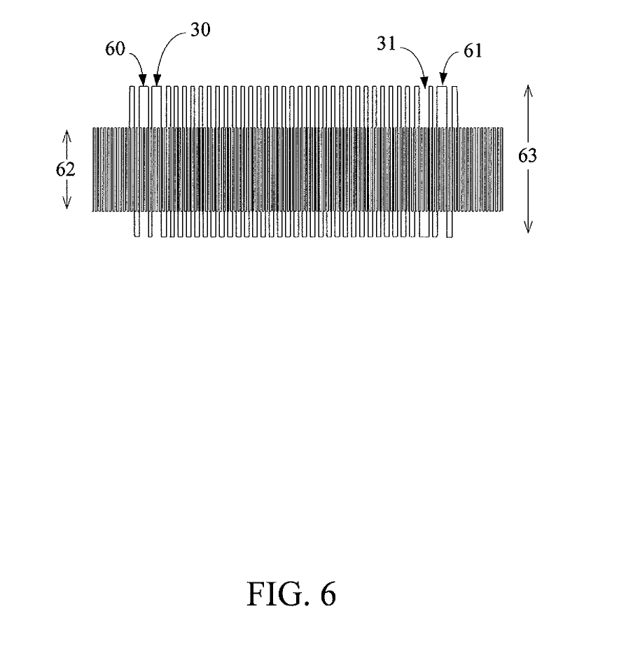

The transmitter 50 and the power supplier 52 can operate at the same or different frequency. If the transmitter 50 and the power supplier 52 operate at the same frequency, a peak value of the command 53 is configured to be much higher than that of the power so that the destructive interference of the command 53 and the continuous wave sent by the power supplier 52 would not influence the command 53 greatly. FIG. 6 shows an example of an RF envelope of the command 53 transmitted by the transmitter 50. The command 53 comprises a head detection symbol 60 and a tail detection symbol 61. The head detection symbol 60 provides a rising edge 30. The tail detection symbol 61 provides a falling edge 31. Amplitude 63 and amplitude 64 are the minimum and maximum amplitudes of the RF envelope. Thus, the command 53 between the head detection symbol 60 and the tail detection symbol 61 can be identified by the difference between the amplitude 63 and amplitude 64.

If the transmitter 50 and the power supplier 52 operate at different frequencies, the receiver 51 can further position the RFID tag 6 according to the frequency of the first response signal. Particularly, the power supplier 52 may provide power to any RFID tag located in the coverage. Since the RFID tag 6, located in the coverage, is powered up by the power supplier 52, the response signal generated by the RFID tag 6 is at the frequency identical to that of the continuous wave. When the receiver 51 receives the response signal, it can realize that the RFID tag 6 is located within the coverage of the power supplier 52 by determining the frequency of the response signal.

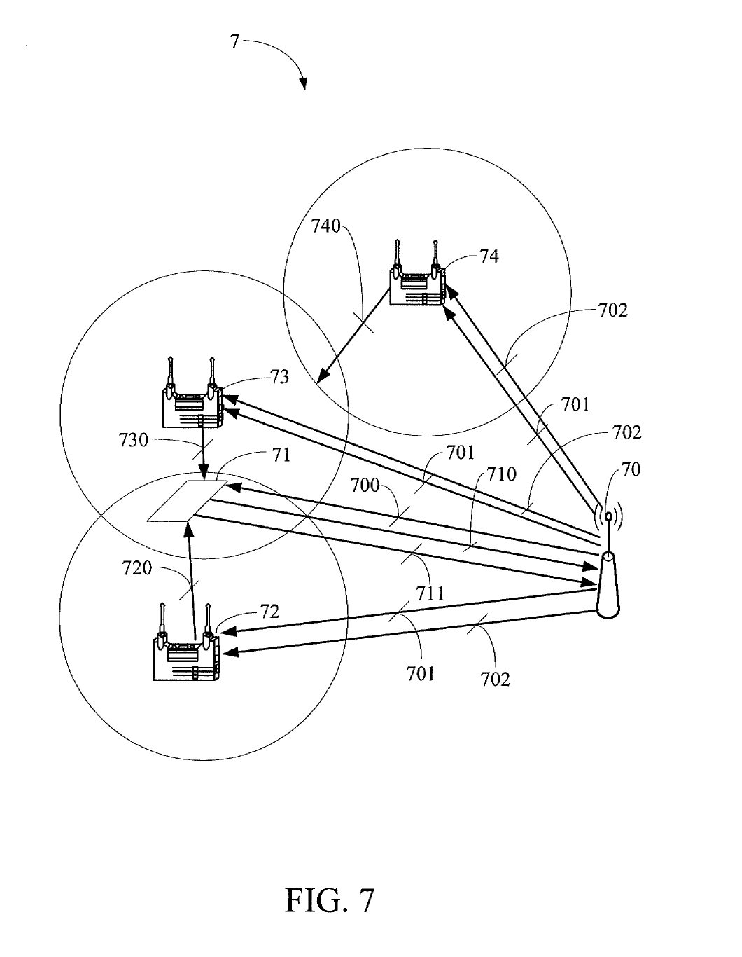

A second embodiment is an RFID system 7 comprising a plurality of power suppliers as FIG. 7 shows. The RFID system 7 comprises a reader 70, an RFID tag 71, and power suppliers 72, 73, and 74 for the sake of exemplification. The reader 70 is configured to transmit a command 700 and receive response signals from the RFID tag 71. The power suppliers 72, 73, and 74 operate at different frequencies. Similarly, the reader 70 first sends an enable signal 701 to turn on the power suppliers 72, 73, and 74. After turned on, the power suppliers 72, 73, and 74 transmit continuous waves 720, 730, and 740 continuously. The RFID tag 71 is then powered up by power obtained from the continuous waves 720 and 730 provided by the power suppliers 72 and 73 since the RFID tag 71 is located in the coverage of the power suppliers 72 and 73. After that, the reader 70 transmits the command 700 to the RFID tag 71, wherein the frequency of the command 700 is different from the frequencies of the power suppliers 72, 73, and 74. The RFID tag 71 then generates a first response signal 710 and a second response signal 711 in response to the command 700, respectively. More specifically, the RFID tag 71 generates the first response signal 710 at the frequency identical to that of the continuous wave transmitted from the power suppliers 72. The RFID tag 71 generates the second response signal 711 at the frequency identical to that of the continuous wave transmitted from the power suppliers 73.

The reader 70 is configured to receive the first and second response signals 710 and 711 as well. Since the first and the second response signals 710 and 711 are generated in response to the power provided by different power suppliers, the reader 70 may determine which response signal's strength is higher, and only decodes the response signal with the higher strength because the response signal with the higher strength is much reliable. For example, if the second response signal 711 has the higher strength than the first response signal 710, the receiver of the reader 70 would decode the second response signal 711 and ignore the first response signal 710. After the first and second response signals 710 and 711 are received, the reader 70 sends a disable signal 702 to turn off the power suppliers 72, 73 and 74.

The reader 70 is capable of positioning the RFID tag 71 according to the frequencies of the first and second response signals 710 and 711 if the reader 70 and the power suppliers 72, 73, and 74 operate different frequencies. The reader 70 can position the RFID tag 71 according to the frequencies of the response signals if the coverages of the power suppliers 72, 73 and 74 are appropriately arranged.

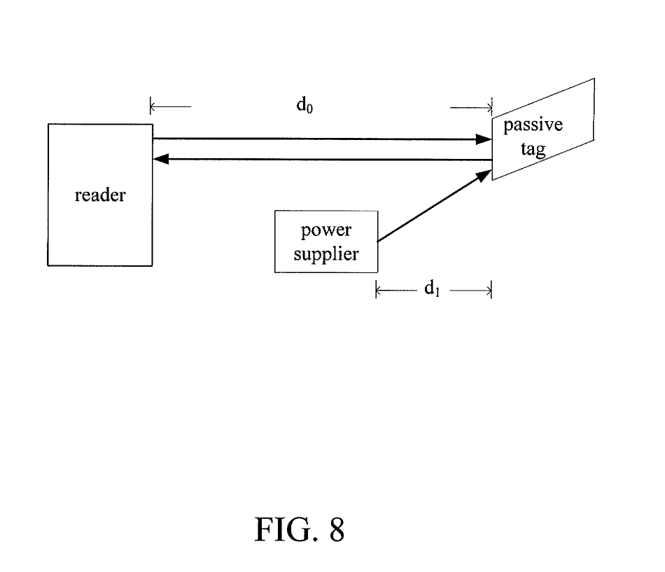

According to the aforementioned configurations, the power needed by RFID tags in an RFID system is provided by at least one independent power supplier. Referring to FIG. 8, one of the passive tags in the RFID system of the present invention is powered up by the nearby power supplier. That is, the distance d₁ is shorter than the distance d₀. The passive tag can receive more power from the power supplier than from a reader. Therefore, the present invention can increase communication distance between an RFID tag and a reader and improve communication quality.

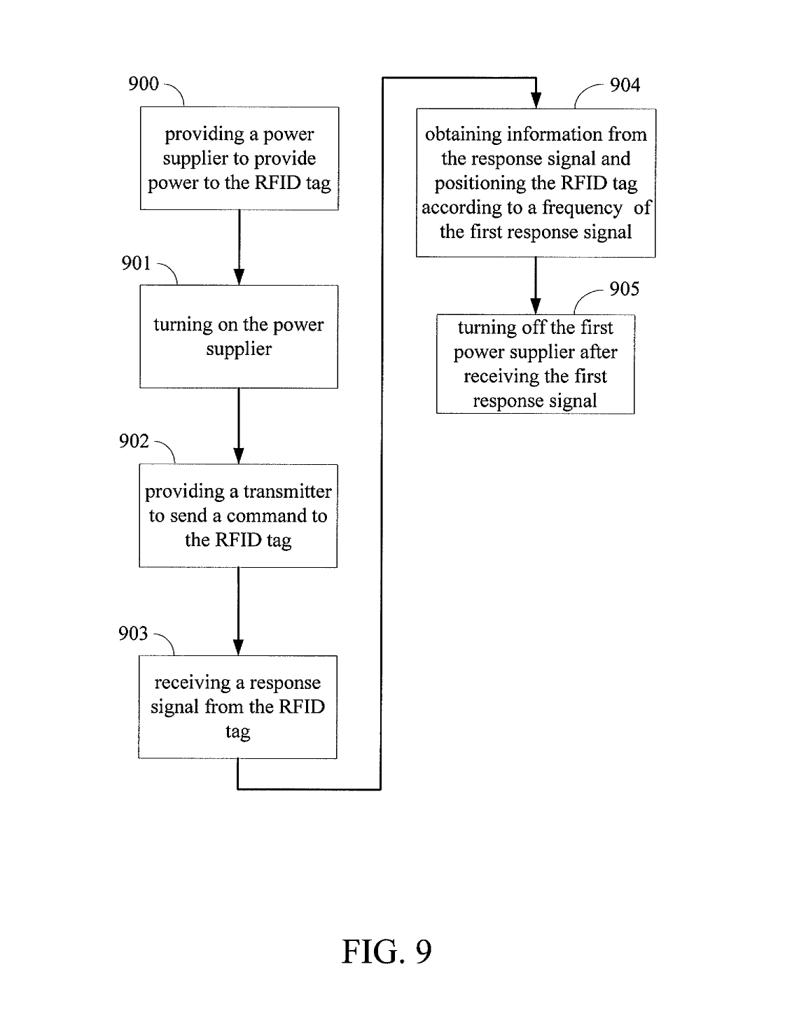

FIG. 9 illustrates a third embodiment of the present invention which is a method for communicating with an RFID tag of an RFID system. The REID system is the one illustrated in the first embodiment. First, step 900 is executed to provide a power supplier to provide power to the RFID tag. Step 901 is then executed to turn on the power supplier. Next step 902 is executed to provide a transmitter to send a command to the RFID tag. Step 903 is then executed to receive a response signal from the RFID tag, wherein the response signal is generated in response to the command. Then step 904 is executed to obtain information from the response signal and position the RFID tag according to the frequency of the response signal. Finally step 905 is executed to turn off the power supplier after receiving the response signal. It is noted that step 905 is not necessary to be executed after receiving the response signal in every embodiment of the present invention. It could be executed after operations of the whole RFID system are finished. In other words, step 905 can be executed up to actuality of the RFID system.

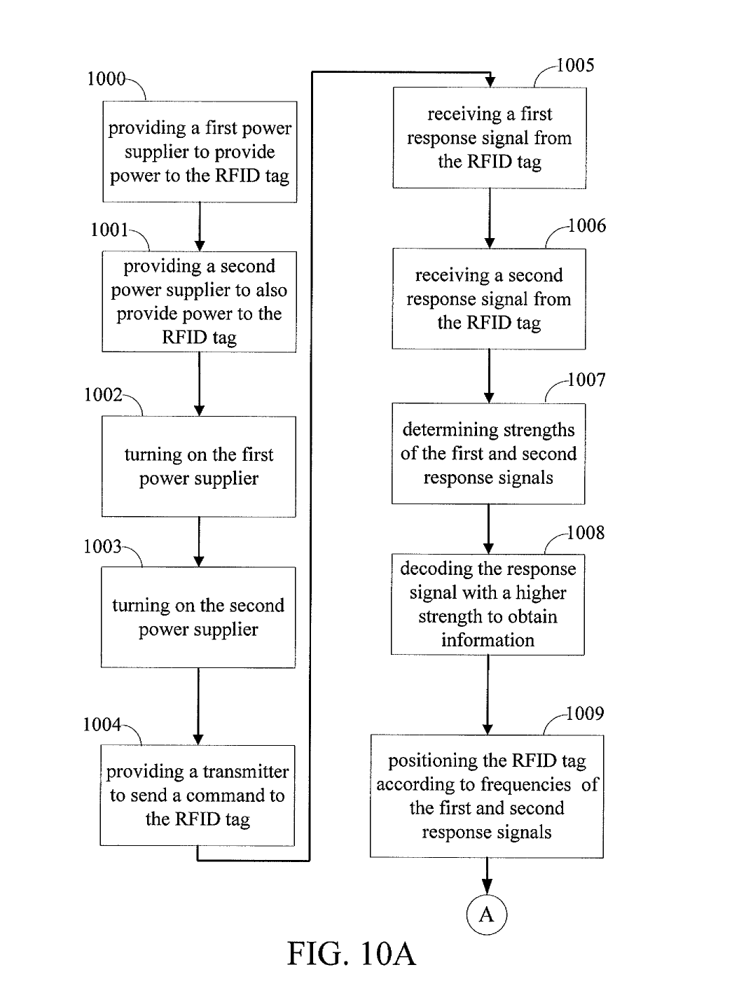

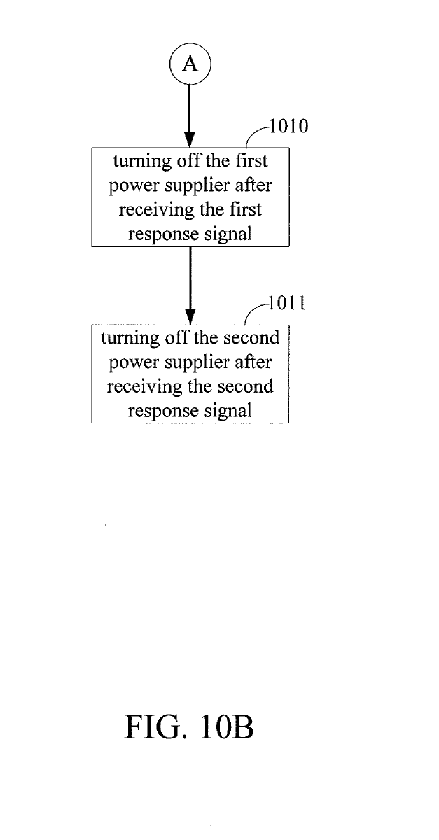

FIGS. 10A and 10B jointly illustrate a fourth embodiment of the present invention which is a method for communicating with an RFID tag of an RFID system. The RFID system is the one illustrated in the second embodiment. First, Step 1000 is executed to provide a first power supplier to provide power to the RFID tag. Step 1001 is executed to provide a second power supplier to also provide power to the RFID tag. Next step 1002 is executed to turn on the first power supplier. Step 1003 is then executed to turn on the second power supplier.

After that, step 1004 is executed to providing a transmitter to send a command to the RFID tag. Step 1005 is then executed to receive a first response signal from the RFID tag, wherein the first response signal is generated in response to the command and by using the power obtained from the first power supplier. Step 1006 is executed to receive a second response signal from the RFID tag, wherein the second response signal is generated in response to the command and by using the power obtained from the second power supplier. Step 1007 is executed to determine strengths of the first and second response signals. Step 1008 is executed to decode the response signal with a higher strength to obtain information. Step 1009 is executed to position the RFID tag according to frequencies of the first and second response signals. Step 1010 is executed to turn off the first power supplier. Finally step 1011 is executed to turning off the second power supplier.

It is noted that the sequence of steps is not a limitation of the present invention. For example, the step 1001 may be executed at the same time as or before the step 1000 is executed. Likewise, steps 1010 and 1011 and steps 1002 and 1003, may be executed at the same time or in other orders.

According to aforementioned descriptions, the present invention utilizes an independent power supplier to provide power to a passive RFID tag so the transmitter of the reader may not be the main device to provide power to the passive RFID tag. The fading of a radio wave is reduced and the power which the RFID tag can receive increases because the distance between the RFID tag and the power supplier is much shorter than that between the RFID tag and the reader. Therefore, the present invention can efficiently overcome that the conventional RFID system using passive tags has a short communication distance and bad communication quality.

The above disclosure is related to the detailed technical contents and inventive features thereof. People skilled in this field may proceed with a variety of modifications and replacements based on the disclosures and suggestions of the invention as described without departing from the characteristics thereof. Nevertheless, although such modifications and replacements are not fully disclosed in the above descriptions, they have substantially been covered in the following claims as appended.

What is claimed is:

1. A radio frequency identification (RFID) system for communicating with an RFID tag, comprising:
a first power supplier for providing power to the RFID tag;
a transmitter for sending a command to the RFID tag; and
a receiver for receiving a first response signal from the RFID tag;
wherein the first response signal is generated in response to the command.

2. The RFID system as claimed in claim 1, wherein the transmitter and the first power supplier operate at the same frequency, and a peak value of the command is higher than a peak value of the power.

3. The RFID system as claimed in claim 1, wherein the command starts with a head detection symbol to provide a rising edge and ends with a tail detection symbol to provide a falling edge.

4. The RFID system as claimed in claim 1, wherein the transmitter and the first power supplier operate at different frequencies.

5. The RFID system as claimed in claim 4, further comprising a second power supplier for providing power to the RFID tag, wherein the transmitter, the second power supplier, and the first power supplier operate at different frequencies.

6. The RFID system as claimed in claim 5, wherein the RFID tag sends the first response signal after being powered up by the power provided by the first power supplier, the RFID tag sends a second response signal after being powered up by the power provided by the second power supplier, and the receiver further receives the second response signal, determines strengths of the first and second response signals, and decodes the response signal with a higher strength.

7. The RFID system as claimed in claim 5, wherein the RFID tag sends the first response signal after being powered up by the power provided by the first power supplier, the RFID tag sends a second response signal after being powered up by the power provided by the second power supplier, and the receiver further receives the second response signal, and positions the RFID tag according to frequencies of the first and second response signals.

8. The RFID system as claimed in claim 1, wherein before sending the command, the transmitter turns on the first power supplier.

9. The RFID system as claimed in claim 1, wherein after receiving the first response signal, the receiver turns off the first power supplier.

10. The RFID system as claimed in claim 5, wherein before sending the command, the transmitter turns on the second power supplier.

11. The RFID system as claimed in claim 6, wherein after receiving the second response signal, the receiver turns off the second power supplier.

12. A method for communicating with an RFID tag, comprising steps of:
providing a first power supplier to provide power to the RFID tag;
providing a transmitter to send a command to the RFID tag; and
receiving a first response signal from the RFID tag;
wherein the first response signal is generated in response to the command.

13. The method as claimed in claim 12, wherein the transmitter and the first power supplier operate at the same frequency.

14. The method as claimed in claim 12, wherein a peak value of the command is higher than a peak value of the power.

15. The method as claimed in claim 12, wherein the command starts with a head detection symbol to provide a rising edge and ends with a tail detection symbol to provide a falling edge.

16. The method as claimed in claim 12, wherein the transmitter and the first power supplier operate at different frequencies.

17. The method as claimed in claim 12, further comprising steps of:
providing a second power supplier to provide power to the RFID tag, wherein the RFID tag sends the first response signal after being powered up by the power provided by the first power supplier, the RFID tag sends a second response signal after being powered up by the power provided by the second power supplier;
receiving the second response signal;
determining strengths of the first and second response signals; and
decoding the response signal with a higher strength.

18. The method as claimed in claim 12, further comprising steps of:
providing a second power supplier to provide power to the RFID tag, wherein the RFID tag sends the first response signal after being powered up by the power provided by the first power supplier, the RFID tag sends a second response signal after being powered up by the power provided by the second power supplier;
receiving the second response signal; and
positioning the RFID tag according to frequencies of the first and second response signals.

19. The method as claimed in claim 12, further comprising steps of:
turning on the first power supplier before sending the command; and
turning off the first power supplier after receiving the first response signal.

20. The method as claimed in claim 16, further comprising steps of:
turning on the second power supplier before sending the command; and
turning off the second power supplier after receiving the second response signal.
